(19) United States
(12) Patent Application Publication
(10) Pub. No.: US 2013/0036664 A1
(43) Pub. Date: Feb. 14, 2013

(54) Eco-safe plant protector

(71) Applicant: Alcov Nicholas, Arroyo Grande, CA (US)

(72) Inventor: Alcov Nicholas, Arroyo Grande, CA (US)

(73) Assignee: Nicholas Alcov, Arroyo Grande, CA (US)

(21) Appl. No.: 12/925,549

(22) Filed: Oct. 25, 2010

(51) Int. Cl. A01G 13/02; A01G 13/10

(52) U.S. Cl. 47/32

(57) ABSTRACT

An eco-safe plant protector, consisting of a top surface of highly reflective material, preferably silver, which repels aphids, white flies, and other plant pests. A copper material forms a barrier around the perimeter of the plant protector. This repels snails and kills certain micro organisms. An adhesive on the surface of the plant protector traps insects and other plant pests. An important aspect of the eco-safe plant protector is that it deters or kills plant pests by mechanical means rather than ecologically harmful chemicals, increases plant growth and yield and has a pleasant decorative appearance so that it can be used both indoors and outdoors.

### TECHNICAL FIELD

The present invention generally relates to an eco-safe apparatus for protecting plants from pests, and more particularly, to an eco-safe apparatus which protects against many types of pests, has a pleasant appearance, and enhances the growth and yield of the plants they protect.

### BACKGROUND

While many forms of protection for plants that are eco-safe and utilize mechanical and physical means are available, their use is subject to the acceptance of the consumer. Frequently this acceptance is dependence on the appearance of the apparatus presented. These pest deterrents are limited as to the type of pest that they deter. They may deter snails but not insects and vice versa. Brucker, U.S. Pat. No. 4,471,560 describes a series of copper plates to provide a snail barrier. While affective, the device does not attempt to present a decorative appearance and limits its use to snails. While prior inventions may deter some types of pests they do not significantly enhance the growth of the plant if one excludes the implied benefits of preventing damage cause by the pest.

Therefore what is needed is an eco-safe apparatus to deter or kill a broad spectrum of pests, to enhance the growth of the plants they protect, that can be used safely both indoors and outdoors while maintaining a pleasant appearance which will be accepted by the consumer. Described herein, is such an apparatus which provides protection for plants, offers a method of attachment which maintains a pleasant decorative appearance and increases the growth and yield of the plant.

### SUMMARY

In view of the foregoing disadvantages in the prior art, the present invention provides an ecologically safe plant protector which repels snails, as they attempt to climb over the surface. In addition it repels aphids, whiteflies, leafhoppers and other pests as they approach the plant. Crawling insects are trapped on its surface. These are achieved while providing the benefit of increased growth and yield for most plants and a pleasant appearance is maintained.

In one embodiment, the present invention provides a plant protector with a top surface, a bottom surface and an edge. Within the body is an opening which may be preferably centered. The opening may have a shape such as a star, daisy, geometric shape or a circle. The outer edge may have a pleasant appearing shape such as a multi-lobed flower, a snowflake, a geometric shape or other shape containing a repeating pattern around the perimeter. Tinsel, streamers, or other extensions may protrude from the edge at various locations. A slit is provided from the edge to the center opening. The stem, trunk, or branch of the plant is passed along the slit of the plant protector to the center opening of the plant protector. The shape of the plant protector is such that as the edge along one side of the slit is positioned over the other side of the slit, a cone shape is achieved. The cone shape can be created with the larger opening facing upward or facing downward. The shape of the foliage of the plant will determine which cone shape is better suited for positioning on the plant. The shape of the plant protector is such that even as one edge at the slit is positioned over a portion of the other side of the slit, the general pleasant appearance of the plant protector is retained.

### BRIEF DESCRIPTION OF THE DRAWINGS

These and other features, aspects, and advantages of the present invention will become better understood with regard to the following description, appended claims, and accompanying drawings where:

FIG. 1 is a perspective view of the eco-safe plant protector illustrating the upper surface of a multi-lobed shape with a slit leading from the edge to a center opening.

FIG. 2 is a perspective view of the eco-safe plant protector illustrating a means of maintaining its position once on the plant.

FIG. 3 is a perspective view of the eco-safe plant protector illustrating the reflective holographic upper surface with a boundary of copper foil.

FIG. 4 is a perspective view of the eco-safe plant protector illustrating the lower surface with copper foil over a center opening and a means of attachment.

FIG. 5 is a perspective view of the eco-safe plant protector illustrating the upper surface with adhesive.

FIG. 6 is a perspective view illustrating two plants with eco-safe plant protectors accommodating the shape of the foliage of the plants.

FIG. 7 is a perspective view of the eco-safe plant protector illustrating the upper surface in an un-rolled state.

FIG. 8 is a perspective view of a portion of a roll of eco-safe plant protectors illustrating the perforations in the upper surface.

### DETAILED DESCRIPTION OF THE INVENTION

It should be noted that the terms “first”, “second”, and the like, herein do not denote any order, quantity, or importance, but rather are used to distinguish one element from another. Further, the terms “a” and “an” herein do not denote a limitation of quantity, but rather denote the presence of at least one of the referenced item.

The present invention provides a plant protector which repels and/or kills plant pests while increasing the growth and yield of the plant. While the examples provide an invention which repels and/or kills plant pests and increases the growth and yield by physical, rather than chemical means, the use of chemicals and or alternative methods may apply.

In one embodiment, the upper portion has a reflective surface, preferably silver, which has resistance to outdoor exposure of rain and wind. The reflective material may be made of foil such as aluminum, and/or plastic, vinyl and the like, or it may have a film such as a holographic, biaxially oriented polypropylene film or other such material adhered to a surface to provide the reflective silver surface.

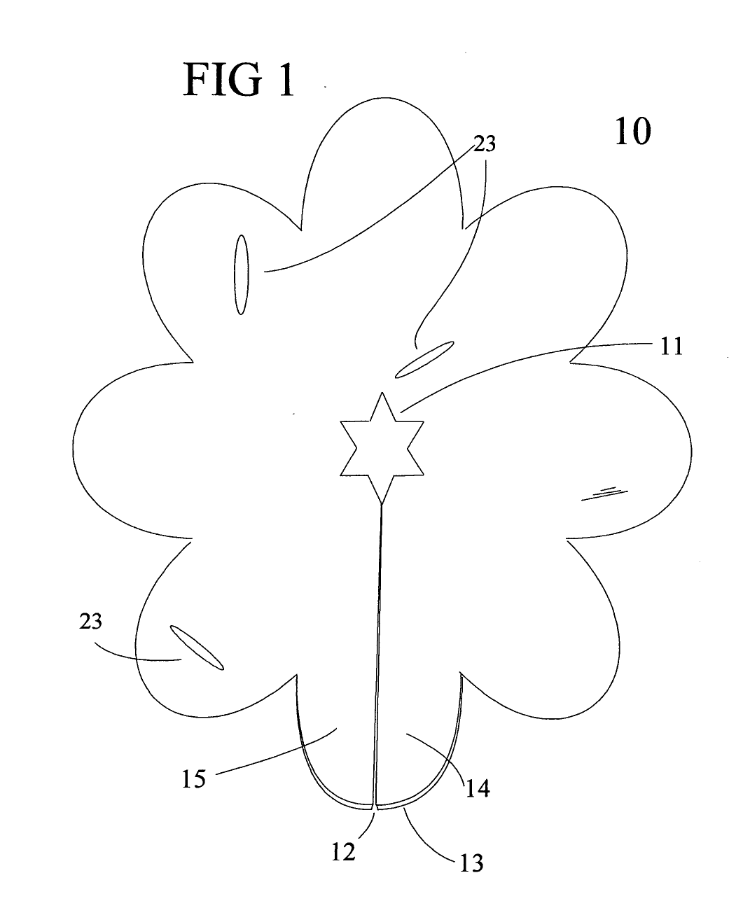

FIG. 1 illustrates a plant protector, the shape of which has a pleasant appearance such as multi-lobed flower shape 10. Stars, geometric shapes, a circle or others such as snowflakes may also be utilized. Tinsel or streamers (not shown) at various locations may be utilized. An opening 11 located at or near the center of the plant protector may have a shape which aids in holding the opening against the plant. While a circular shape may be utilized for the center opening, shapes which have irregularities such as stars which come in contact with the plant and can create a fold around the plant are better suited for holding the plant protector in place. A slit 12 from the edge 13 of the plant protector to the opening 11 is utilized to position the plant protectors around the trunk, stem, or branch of the plant. The repeating shape of the perimeter of the plant protector is such that when the surface 14 on one side of the slit 12 is positioned over the surface 15 on the other side of the slit 12, a semblance of the original shape is maintained or in other styles an illusionary transformational different pleasing shape is achieved. The action of moving the edges over each other decreases the size of the opening 11, thus securing the plant protector against the plant and creates a funnel like shape. Openings 23 throughout the surface reduce wind resistance so that the plant protector does not get blown off on windy days.

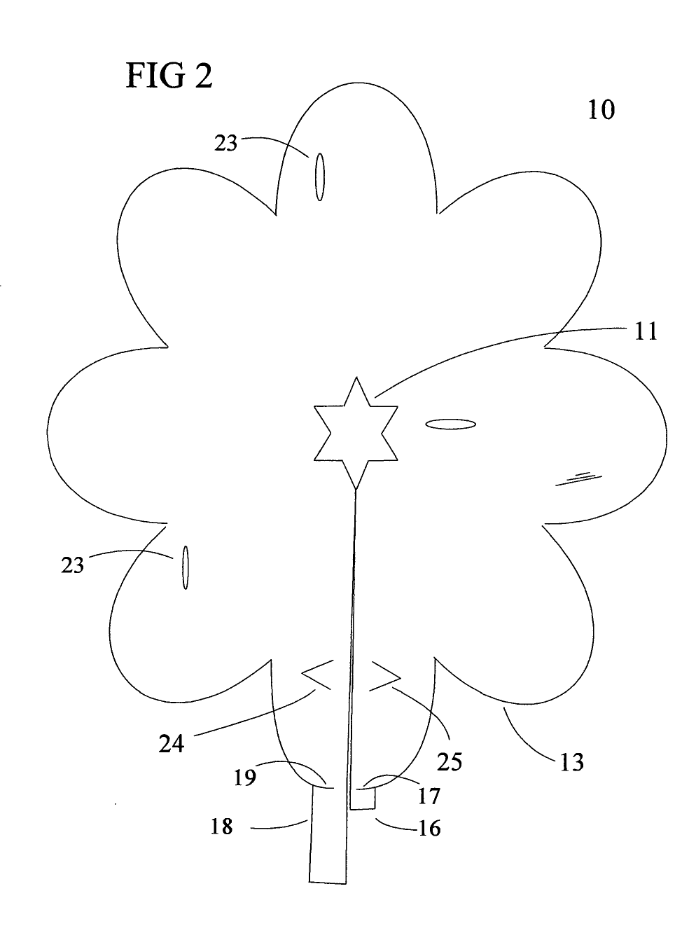

FIG. 2 illustrates the upper surface of the plant protector 10 with a means of maintaining the plant protector in place once it has been positioned around the plant. The means can be achieved by using inserting cuts 24 on one side of slit 12 which fit into receiving cuts 25 on the other side of the slit. 12 as the edges are moved over each other. Another means is to position the slit 17 of short tab 16 into the slit 19 of long tab 18. Short tab 16 is then bent over long tab 18. Long tab 18 is then bent over the bent short tab 16 and onto the surface of the plant protector. These tabs can be kept in place by means such as double sided tape, glue, paper clip, staple and/or other holding means.

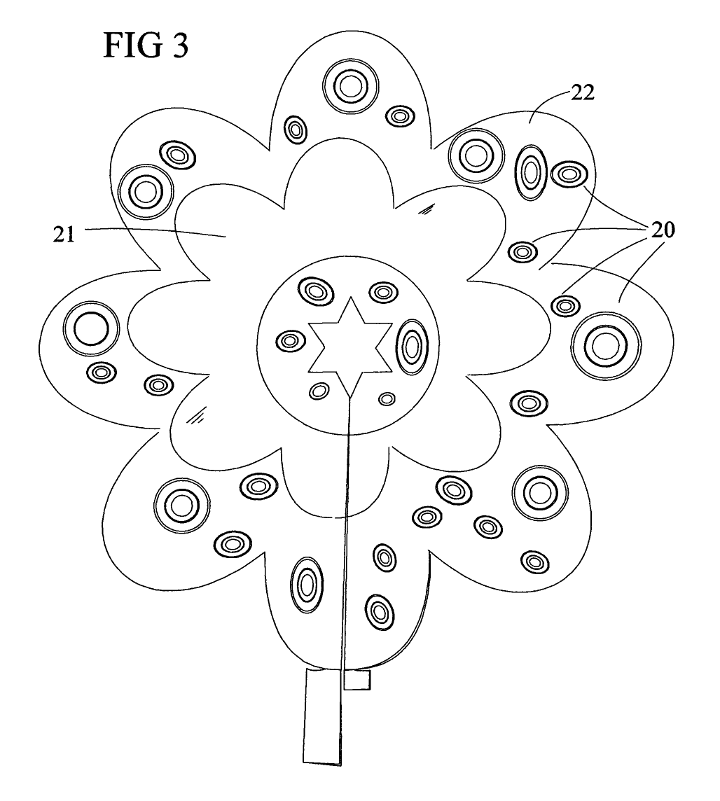

FIG. 3 illustrates the top surface of the eco-safe plant protector with a reflective holographic film with one of many possible patterns such as the circles pattern 20 shown. The background 22 is preferably a silver mirror finish. Positioned along the perimeter of the top surface is a width of copper 21 which provides a barrier against snails and other pests from further movement up the plant. This barrier may be achieved with the use of copper foil in a decorative pattern. The copper foil may be adhered to the surface by means such as a conductive adhesive, double sided tape and the like, which maintains the electrical conductivity of the copper foil used to repel the snails. A more expensive scenario would use copper as the surface base and adhere reflective silver foil or holographic film to the areas of the copper. The copper repels snails and kills strains of bacteria, mold, fungus and other micro-organisms which are detrimental to plants.

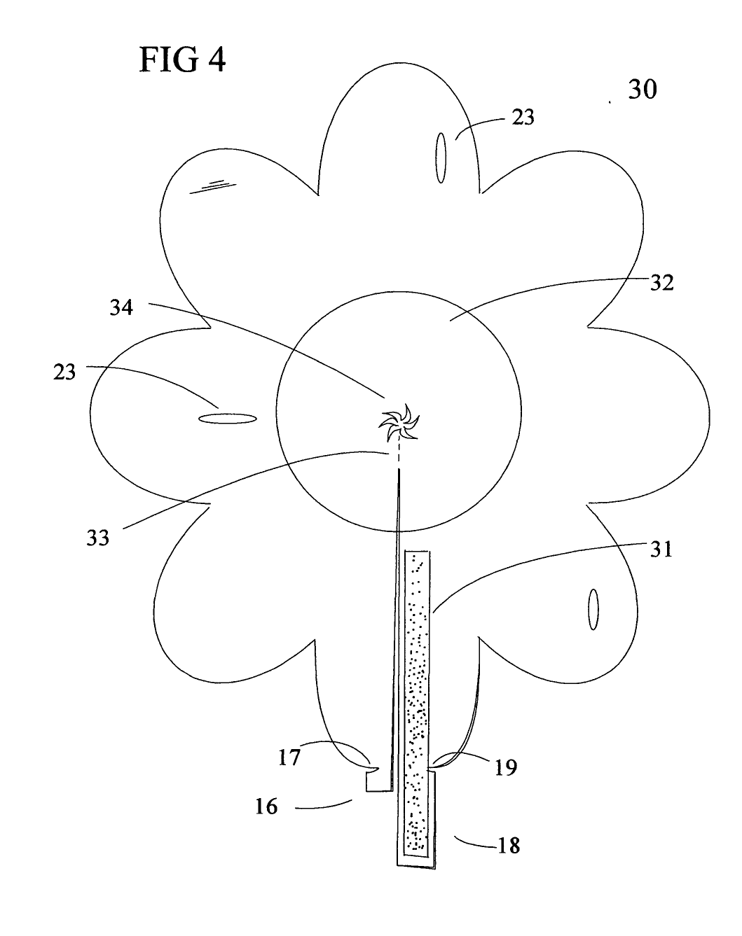

FIG. 4 illustrates the bottom surface 30 of the eco-safe plant protector. Once the plant protector is in position around the plant, the shorter tab 16 is inserted into the slit 19 of the longer tab 18. A protective non stick strip (not shown) is removed from a strip of double sided tape 31 on the back of longer tab 18. Shorter tab 16 is bent over longer tab 18. Then longer tab 18 is bent over and pressed against the bottom surface to hold the plant protector in place once the opening has been reduced to the size required to grip the plant. A paper clip, staple or other means can be utilized to assist in holding the two edges together. While this example uses different sized tabs, the sizes and any differences in the tabs and their location on the plant protector are for exemplary purposes and should not be construed as a restrictive factor. A surface of copper 32 such as copper foil, larger than the center opening 11 shown in FIG. 3, provides a barrier from pests climbing through the center opening. A slit, perforation 33 or other means of allowing the passage of the plant toward the center of the plant protector past the copper foil can be utilized. An opening such as the pin wheel shape 34 in the center of the copper foil aids in maintaining the position of the plant protector on the plant. Other pointed and jagged shapes may be utilized and achieved by means such as punches, cutting tools and the like. The opening in the copper foil should be preferably smaller than the center opening to help hold the plant protector in place and especially for plants with a stem smaller than the opening of the upper surface. Adhesive on the copper foil is one means of aiding in securing the plant protector onto the plant. The copper foil folds around the plant yet keeps the opening somewhat closed against pests.

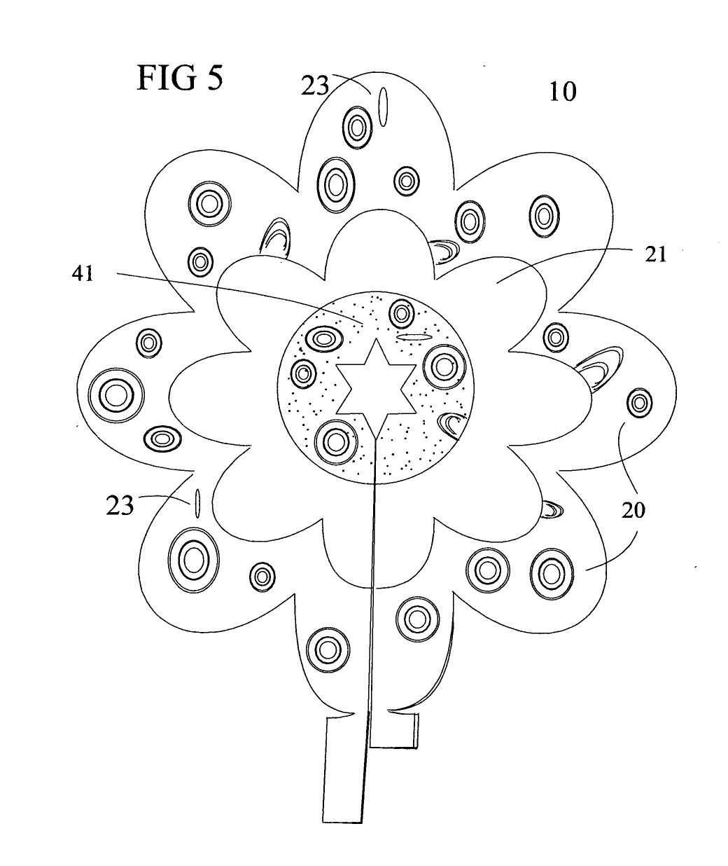

FIG. 5 illustrates the top surface 10 of the eco-safe plant protector with a film of water resistant adhesive 41 around the center area. The adhesive is a type which remains tacky for extended periods of time. The adhesive 41 would preferably be non-toxic and bio degradable. Insects crawling up the plant from below the plant protector would be trapped by the adhesive. An attractant or bait at the location of the adhesive would provide additional defense against pests. An additional means of killing plant pests such as food grade diatomaceous earth does so by a physical rather than chemical action. The diatomaceous earth would be applied on the surface of the plant protector. A means of securing the diatomaceous earth to the plant protector could include a peal and stick covering which when removed exposes it to the pests. The diatomaceous earth could be dusted on top of the adhesive and/or other areas of the plant protector. A covering of non stick material such as waxed paper (not shown) covering the adhesive would be removed prior to use, to expose the adhesive, bait, and diatomaceous earth. Other means of killing plant pests are also contemplated. While the illustration shows the adhesive on a location at the upper surface other locations such as on the lower surface or both may be utilized.

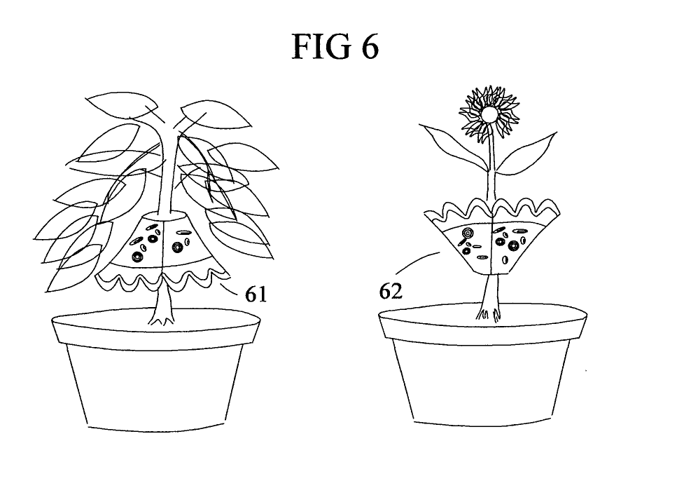

FIG. 6 illustrates, as previously mentioned, that as one side of the plant protector is positioned over the other side, a funnel shape is created. By pushing upward with the fingertips on the bottom surface, while pushing downward on the edges of the top surface with the thumbs, as the sides of the slit are moved over each other, a funnel shape with the larger opening facing downward 62 is created. Reversing the pressures creates a funnel with the larger opening facing upward 61. The shape of the foliage of the plant will determine which shape to use. Frequently as in the case of vegetables, there will be instances where there will be only a small distance between the soil and the foliage of the plant in which to form a barrier between snails, insects, other pests, and the leaves of the plant. The ability to choose the shape which best fits this small space provides an added benefit not provided by prior art.

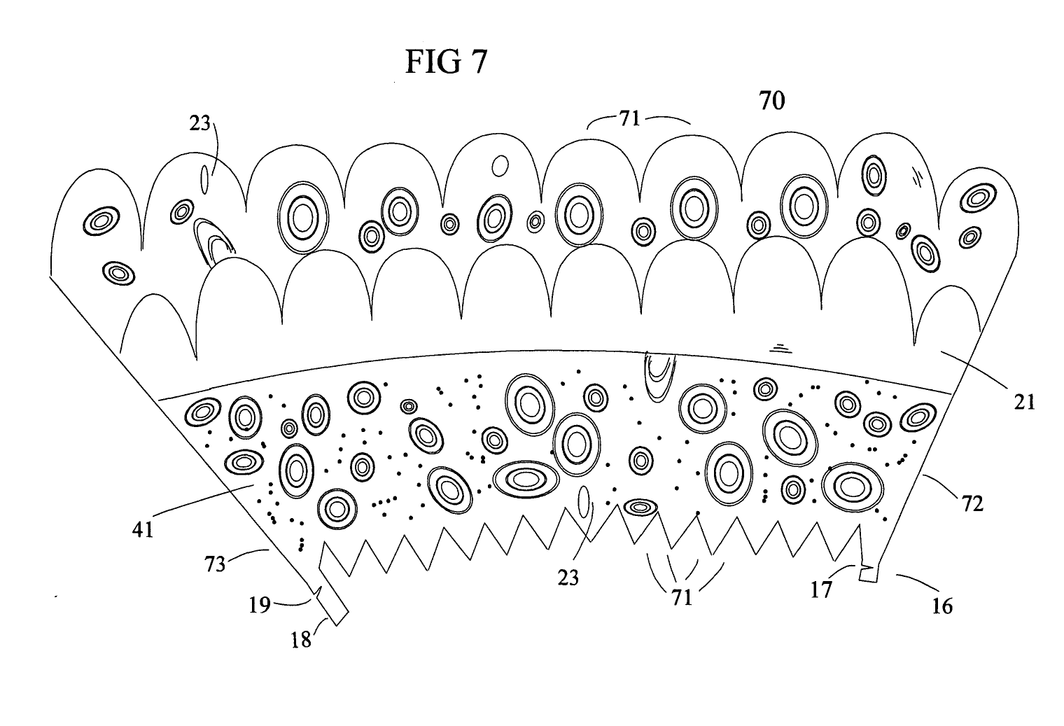

FIG. 7 illustrates a top surface 70 of an unrolled eco-safe plant protector with highly reflective covering, with a scalloped edge 71. A copper foil 21 is attached such that when the edges 72 and 73 are over lapped, and attachment tabs 16 and 18 are connected at the slits 17 and 19 and over lapped, a continuous perimeter of copper material is achieved. Adhesive material 41 is covered with a non stick material (not shown) which is removed once the plant protector is in position on the plant. Openings 23 throughout the surface reduce wind resistance.

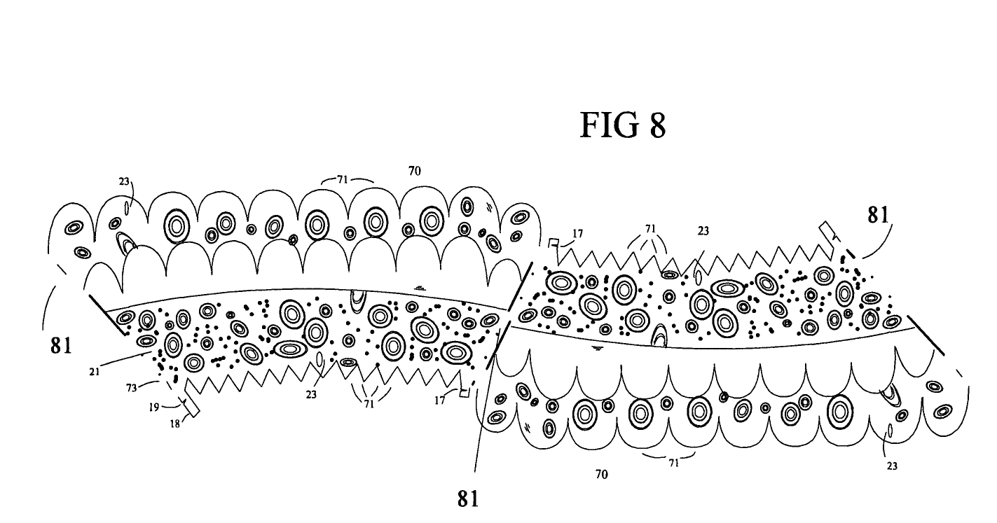

The roll of eco-safe plant protectors can be prepared so that an individual plant protector is held in place next to another plant protector with a means such as a perforation 81 as illustrated in FIG. 8. This means allows easy removal from the remainder of the roll. Other means would include adhesive tape, clips and the like.

While the foregoing description discusses growth enhancement as the result of the reflective properties of the surface material, other means such as impregnating a component of the plant protector with a fertilizers or a pesticide such that when it comes in contact with water, a predetermined amount is released thus providing benefit to the plant. Other means of enhancing the plant can also be incorporated into the plant protector.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed:

1. An eco-safe plant protector comprising:
a surface, the surface having a top, a bottom and an edge, with an opening at or near its center, with a slit from the edge to the center opening, with said surface shaped in a decorative pattern designed such that when the two edges created by the slit are overlapped, the decorative shape is still retained, with the top of said surface being highly reflective, preferably silver, with a copper material applied to form a boundary around the perimeter of said top surface, with said bottom surface to which a copper material is applied to form a boundary around a portion of said bottom surface, with an adhesive material applied to said surface, with a means of attachment.

2. The eco-safe plant protector in claim 1 wherein a pesticide is attached to surface.

3. The eco-safe plant protector in claim 1 wherein a fertilizer is attached to the surface.

4. The eco-safe plant protector of claim 1 wherein a pest bait is attached to the surface.

5. The eco-safe plant protector of claim 1 wherein a non chemical pest deterrent is applied to the surface.

6. The eco-safe-plant protector of claim 1 wherein a means to reduce wind resistance is provided.

7. The eco-safe plant protector of claim 1 wherein a plurality of plant protectors are positioned in a roll.

8. The eco-safe plant protector of claim 1 wherein the apparatus can be shaped to accommodate the foliage of the plant.

9. The eco-safe plant protector of claim 1 wherein, tinsel, streamers, or other plurality of extensions are provided.
